(19) United States
(12) Patent Application Publication
(10) Pub. No.: US 2016/0223879 A1
(43) Pub. Date: Aug. 4, 2016

(54) COLOR DISPLAY APPARATUS AND MANUFACTURING METHOD THEREOF

(71) Applicant: E Ink Holdings Inc., Hsinchu City (TW)

(72) Inventor: WEI-CHEN TSAI, Hsinchu (TW)

(21) Appl. No.: 14/808,050

(22) Filed: Jul. 24, 2015

(30) Foreign Application Priority Data
Feb. 3, 2015 (TW) 104103628

(51) Int. Cl. G02F 1/167; G02F 1/1335

(52) U.S. Cl. CPC G02F 1/167; G02F 1/133514; G02F 1/133516

(57) ABSTRACT

A color display apparatus is provided. The color display apparatus includes a black-and-white display module and a color filter layer, wherein the color filter layer is disposed on the black-and-white display module. The color filter layer includes a translucent base and a plurality of color filter patterns, wherein the translucent base is disposed on the black-and-white display module. The color filter patterns are embedded in the translucent base, and a first surface of each color filter pattern away from the black-and-white display module is exposed from a second surface of the translucent base away from the black-and-white display module, wherein the first surfaces and the second surface are coplanar, and the first surfaces and the second surface are in contact with a dielectric gas or covered by a protective layer. A manufacture method for the color display apparatus is also provided.

### FIELD OF THE INVENTION

The present invention relates to a display apparatus, and more particularly to a color display apparatus and a manufacturing method thereof.

### BACKGROUND OF THE INVENTION

With advancement of flat screen display technology, diverse flat screen apparatuses have become available in the market for meeting different needs of consumers. Electrophoretic display apparatuses save energy, and are light weight and slim. Consequently, electrophoretic display apparatuses are becoming ever more popular. Early electrophoretic display apparatuses can only display black-and-white images. In order to use electrophoretic display apparatuses to display color images, conventional techniques dispose color filters at electrophoretic displays.

FIG. 1 is a schematic diagram of a conventional color electrophoretic display apparatus. Referring to FIG. 1, a conventional electrophoretic display apparatus 100 includes an array substrate 110, a front plane laminate 120, a color filter substrate 130 and an enclosed adhesive layer 140. The front plane laminate 120 is arranged on the array substrate 110 and includes an electrophoretic display layer (not shown). The array substrate 110 drives the electrophoretic display layer to display images. Additionally, in order to achieve the object of display color images, the color filter substrate 130 is jointed to the array substrate 110 through the enclosed adhesive layer 140 in the conventional techniques.

The conventional color filter substrate 130 includes a thin glass panel 132, a plurality of color filter patterns 134 arranged at the thin glass panel 132, and a carrier panel 136 for carrying the thin glass panel 132. The thin glass panel 132 is thin and therefore difficult to manufacture, so the carrier panel 136 is used during manufacture of the thin glass panel 132. After the color filter substrate 130 is jointed to the array substrate 110 through the enclosed adhesive layer 140, the carrier panel 136 is removed.

However, the enclosed adhesive layer 140 is liquid prior to curing and is prone to leaking out and contacting the sides of the carrier panel 136 and the thin glass panel 132, resulting in attachment between and difficulty in separating the carrier panel 136 and the thin glass panel 132. Consequently, the manufacture efficiency of a conventional color electrophoretic display apparatus 100 is compromised. Additionally, given that a conventional electrophoretic display apparatus 100 displays images by reflecting ambient light, and that some of the ambient light is reflected by the thin glass panel 132 and does not reach the front plane laminate 120, the optical efficiency of the electrophoretic display apparatus 100 is compromised. Moreover, reflection by the thin glass panel 132 affects the quality of display.

### SUMMARY OF THE INVENTION

One object of the present disclosure is to provide a color display apparatus which is easy to manufacture.

Another object of the present disclosure is to provide a method of manufacturing a color display apparatus, for increasing manufacturing efficiency of a color display apparatus.

The present disclosure provides a color display apparatus, which includes a black-and-white display module and a color filter layer. The color filter layer is disposed on the black-and-white display module. The color filter layer includes a translucent base and a plurality of color filter patterns. The translucent base is disposed on the black-and-white display module. The color filter patterns are embedded in the translucent base. A first face of each of the color filter patterns distal from the black-and-white display module is exposed at a second face of the translucent base distal from the black-and-white display module. The first faces of the color filter patterns and the second face of the translucent base are in contact with a dielectric gas.

In an embodiment of the present disclosure, the material of the translucent base includes optically clear resin.

The present disclosure further provides a color display apparatus, which includes a black-and-white display module, a color filter layer and a protective layer. The color filter layer is disposed on the black-and-white display module. The color filter layer includes a translucent base and a plurality of color filter patterns. The translucent base is disposed on the black-and-white display module. The color filter patterns are embedded in the translucent base. A first face of each of the color filter patterns distal from the black-and-white display module is exposed at a second face of the translucent base distal from the black-and-white display module. The protective layer has a bottom face directly contacting and covering the first faces of the color filter patterns and the second face of the translucent base. The protective layer is a clear adhesive layer or an optical film.

In an embodiment of the present disclosure, the material of the translucent base includes optically clear resin, and the material of the clear adhesive layer includes optically clear resin or optically clear adhesive.

In an embodiment of the present disclosure, if the protective layer is a clear adhesive layer, the color display apparatus further includes a glass panel attached to the clear adhesive layer. A thickness of the glass panel is less than 400 micrometers.

In an embodiment of the present disclosure, the optical film includes anti-reflective film or anti-glare film.

The present disclosure still further provides a method of manufacturing a color display apparatus including steps of: forming a plurality of color filter patterns on a substrate; coating the substrate with a liquid adhesive to cover the color filter patterns; attaching the substrate, through the liquid adhesive, onto a black-and-white display module; curing the liquid adhesive, wherein the liquid adhesive forms a translucent base; and removing the substrate.

In an embodiment of the present disclosure, the liquid adhesive includes optically clear resin.

In an embodiment of the present disclosure, the method of manufacturing a color display apparatus further includes steps of: disposing a clear adhesive layer on the translucent base; and attaching a glass panel onto the clear adhesive layer, wherein a thickness of the glass panel is less than 400 micrometers. A thickness of the glass panel is less than 400 micrometers.

In an embodiment of the present disclosure, the method of manufacturing a color display apparatus further includes a step of: disposing an optical film on the translucent base.

Different from structures of conventional color filter substrates, in the color display apparatus and the method of manufacturing the same of the present disclosure, the color filter patterns are directly embedded in the translucent base arranged on the black-and-white display module, and no thin glass panels or carrier panels are required. Therefore, the problem of attachment between the thin glass panel and the carrier panel present in conventional techniques is solved by the present disclosure, thereby increasing the manufacturing efficiency of the color display apparatus.

### BRIEF DESCRIPTION OF THE DRAWINGS

The present invention will become more readily apparent to those ordinarily skilled in the art after reviewing the following detailed description and accompanying drawings, in which:

FIG. 1 shows a schematic diagram of a conventional color electrophoretic display apparatus;

FIG. 2 shows a schematic diagram of a color display apparatus according to an embodiment of the present disclosure;

FIG. 3A to FIG. 3D show a color display apparatus throughout a manufacturing process according to an embodiment of the present disclosure;

FIG. 4 shows a schematic diagram of a color display apparatus according to another embodiment of the present disclosure;

FIG. 5 shows a schematic diagram of a color display apparatus according to still another embodiment of the present disclosure;

FIG. 6A to FIG. 6C show a color display apparatus throughout a manufacturing process according to another embodiment of the present disclosure; and

FIG. 7 shows a schematic diagram of a color display apparatus according to another embodiment.

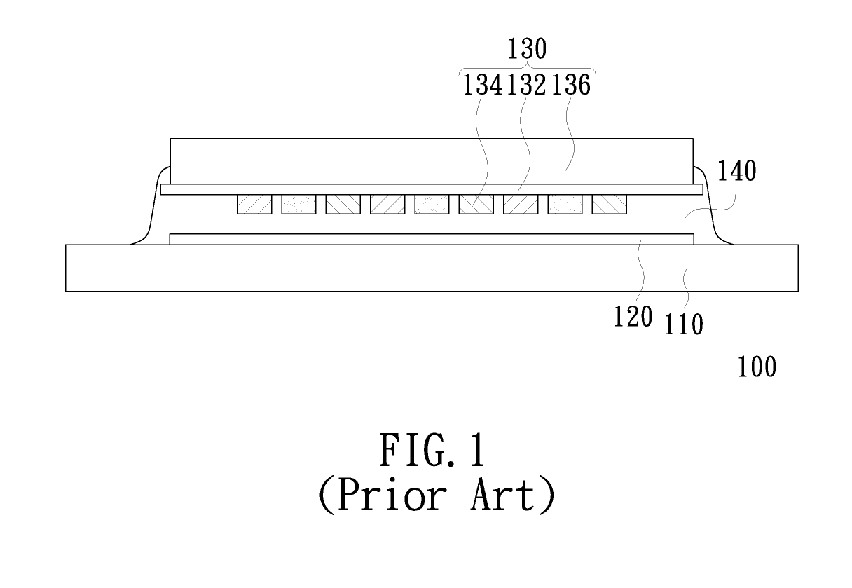

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

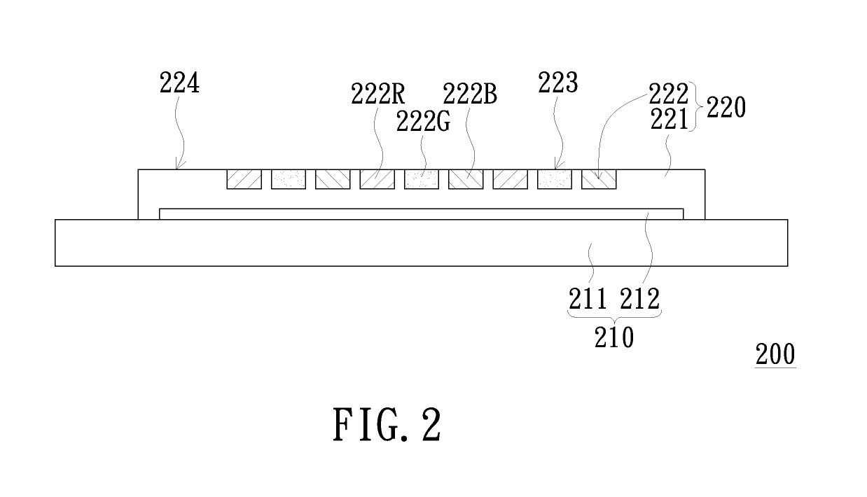

FIG. 2 shows a schematic diagram of a color display apparatus according to an embodiment of the present disclosure. Referring to FIG. 2, a color display apparatus 200 in the present embodiment includes a black-and-white display module 210 and a color filter layer 220. The color filter layer 220 is disposed on the black-and-white display module 210. The color filter layer 220 includes a translucent base 221 and a plurality of color filter patterns 222. The translucent base 221 is disposed on the black-and-white display module 210. The color filter patterns 222 are embedded in the translucent base 221. Each of the color filter patterns 222 has a first face 223 distal from the black-and-white display module 210. The translucent base 221 has a second face 224 distal from the black-and-white display module 210. Each of the first faces 223 of the color filter patterns 222 is exposed at the second face 224 of the translucent base 221. The first faces 223 of the color filter patterns 222 and the second face 224 of the translucent base 221 are in contact with a dielectric gas. In other words, the first faces 223 of the color filter patterns 222 and the second face 224 of the translucent substrate 221 are not covered by other film layer.

In the present embodiment, the black-and-white display module 210 is for example an electrophoretic display module, including an array substrate 211 and a front plane laminate 212. The front plane laminate 212 is arranged on the array substrate 211, and the array substrate 211 is configured to drive the electrophoretic display layer in the front plane laminate 212 to display images. However, the present disclosure does not limit the type of the black-and-white display module 210. For example, the black-and-white display module can also be a liquid crystal display module, an electrowetting display module, a liquid powder display module, etc.

The translucent base 221 in the present embodiment is for example cured liquid adhesive. The material of the translucent base 221 can be an optically clear resin. The color filter patterns 222 can be embedded into the liquid adhesive (e.g. optically clear resin) through transfer printing. When the liquid adhesive adhered on the black-and-white display module 210 is cured and becomes the translucent base 221, the color filter patterns 222 become fixed over the black-and-white display module 210 for adding color to images displayed by the black-and-white display module 210. The color filter pattern 222 can include red filters 222R, green filters 222G, blue filters 222B, etc. In another embodiment, the color filter patterns 222 can include yellow filters, cyan filters, and magenta filters. The following, in conjunction with the figures, describes a method of manufacturing the abovementioned color display apparatus 200.

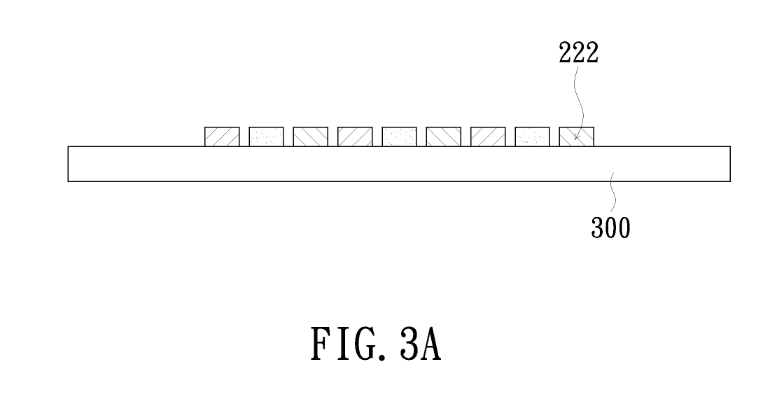

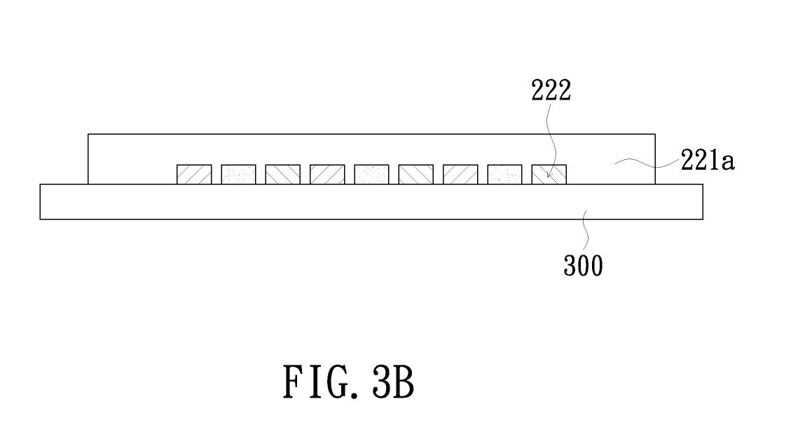

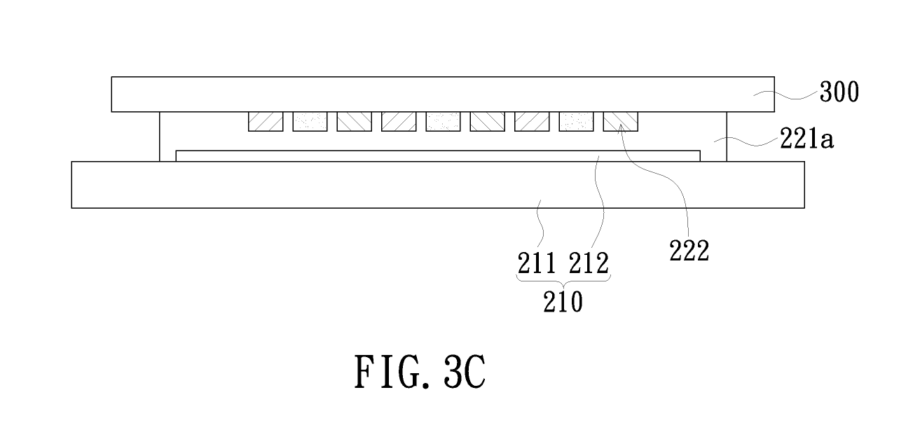

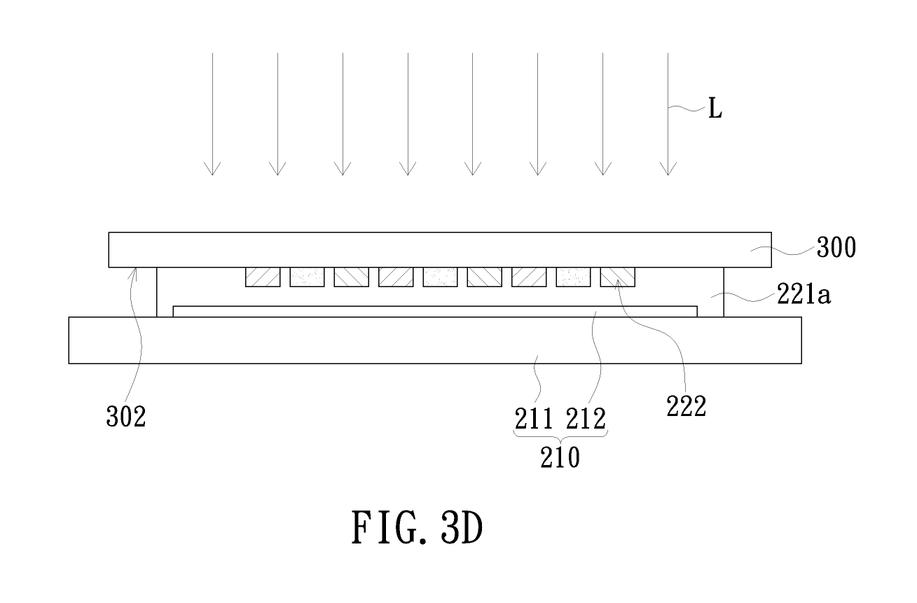

FIG. 3A to FIG. 3D show a color display apparatus throughout a manufacturing process according to an embodiment of the present disclosure. Referring to FIG. 3A, according to the method of manufacturing a color display apparatus of the present embodiment, for example, a plurality of color filter patterns 222 are formed on a substrate 300. In the present embodiment, the method of forming the color filter patterns 222 is for example printing, but is not limited thereto.

Next, as shown in FIG. 3B, liquid adhesive 221a is coated on the substrate 300 to cover the color filter patterns 222. The liquid adhesive 221a in the present embodiment is for example an optically clear resin. The material of the liquid adhesive 221a can also be other transparent liquid adhesives.

Then, as shown in FIG. 3C, the substrate 300 is attached to the black-and-white display module 210 through the liquid adhesive 221a. In the present embodiment, when the substrate 300 is attached to the black-and-white display module 210, the substrate 300 and the black-and-white display module 210 need to be aligned, such that the color filter patterns 222 align with pixels (not shown) on the black-and-white display module 210.

Then, as shown in FIG. 3D, the liquid adhesive 221a is cured and becomes the translucent base 221 shown in FIG. 2. The method of curing the liquid adhesive 221a can be determined according to the type of the liquid adhesive 221a. For example, when the liquid adhesive 221a is an ultraviolet light curing adhesive, ultraviolet light L can be directed at the liquid adhesive 221a to cure the liquid adhesive 221a and form the translucent base 221 in FIG. 2. In other embodiments, the liquid adhesive can be adhesives curable by other types of light or heat. The present disclosure does not limit the type of the liquid adhesive.

Then, the substrate 300 is removed to form the color display apparatus 200 of FIG. 2. Of particular note, when a surface 302 of the substrate 300 for carrying the color filter patterns 222 (as shown in FIG. 3D) is planar, the first faces 223 of the color filter patterns 222 and the second face 224 of the translucent base 221 in FIG. 2 are coplanar.

Regarding the color display apparatus 200 and the method of manufacturing the same according to the present embodiment, the color filter patterns 222 are embedded in the translucent base 221 and carried by the translucent base 221 attached to the black-and-white display module 210, therefore the thin glass panel used in conventional techniques for carrying the color filter patterns 222 can be omitted. Consequently, the problem of attachment between the thin glass panel and the carrier panel used for carrying the thin glass panel present in conventional techniques is solved by the present disclosure, thereby increasing the manufacturing efficiency of the color display apparatus 200. Additionally, as opposed to conventional techniques, the color filter patterns 222 of the present disclosure are not covered by a thin glass panel, avoiding partial reflection of the ambient light by the thin glass panel, thereby increasing the optical efficiency and image display quality of the color display apparatus 200.

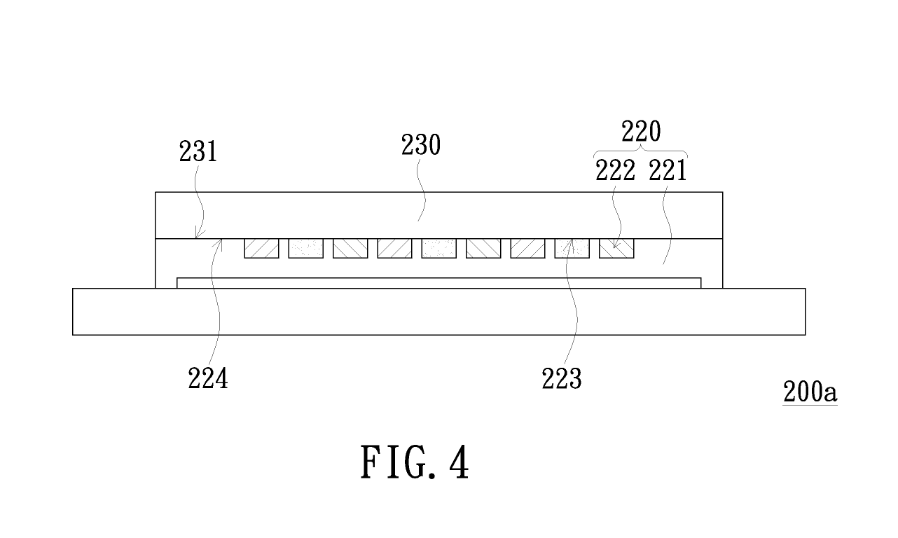

FIG. 4 shows a schematic diagram of a color display apparatus according to another embodiment of the present disclosure. Referring to FIG. 4, the color display apparatus 200a in the present embodiment is similar to the abovementioned color display apparatus 200. A difference lies in that the color display apparatus 200a further includes a protective layer 230 arranged on the translucent base 221. The protective layer 230 has a bottom face 231 facing the translucent base 221, and the bottom face 231 directly contacts and covers the first faces 223 of the color filter patterns 222 and the second face 224 of the translucent base 221. Additionally, the protective layer 230 in the present embodiment is for example an optical film such as an anti-reflective film or an anti-glare film, etc., but is not limited thereto. Arrangement of the optical film improves the optical efficiency and/or the image display quality of the color display apparatus 200a.

The method of manufacturing the color display apparatus 200a is similar to the method of manufacturing the abovementioned color display apparatus 200, with the difference lying in that after forming the abovementioned color display apparatus 200, an optical film is disposed on the translucent base 221 to serve as the protective layer 230.

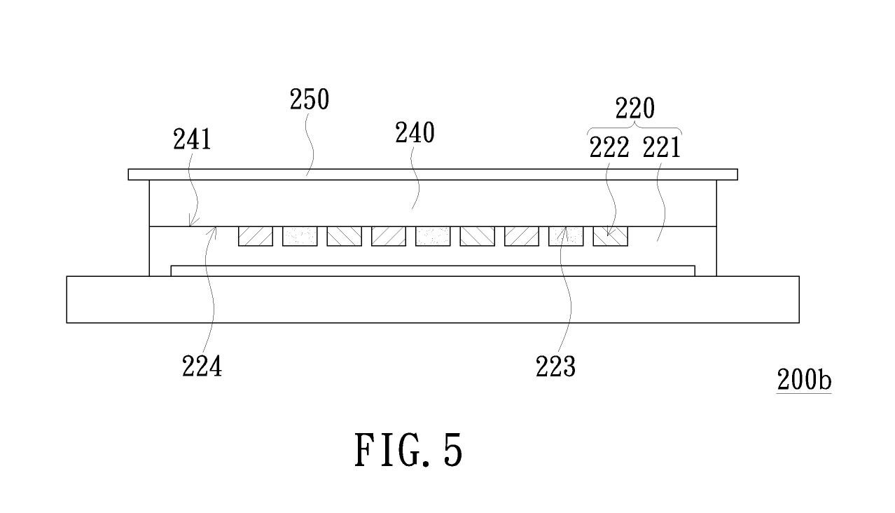

FIG. 5 shows a schematic diagram of a color display apparatus according to still another embodiment of the present disclosure. Referring to FIG. 5, the color display apparatus 200b in the present embodiment is similar to the abovementioned color display apparatus 200, with the difference lying in that the color display apparatus 200b further includes a clear adhesive layer 240 arranged on the translucent base 221. The clear adhesive layer 240 can serve as a protective layer having a bottom face 241 facing the translucent base 221, and the bottom face 241 directly contacts and covers the first faces 223 of the color filter patterns 222 and the second face 224 of the translucent base 221. The material of the clear adhesive layer 240 in the present embodiment is optically clear resin. Additionally, the color display apparatus 200b can further include a glass panel 250 attached on the clear adhesive layer 240. A thickness of the glass panel 250 is for example less than 400 micrometers. In other embodiments, the glass panel 250 can be replaced by other panels, such as a plastic panel, etc.

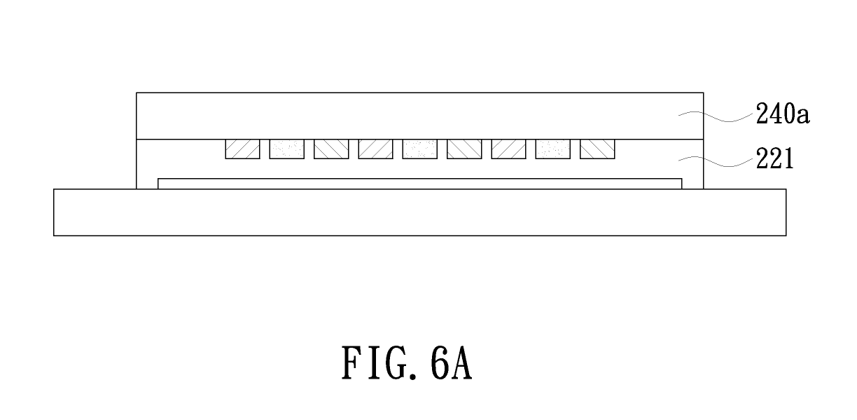

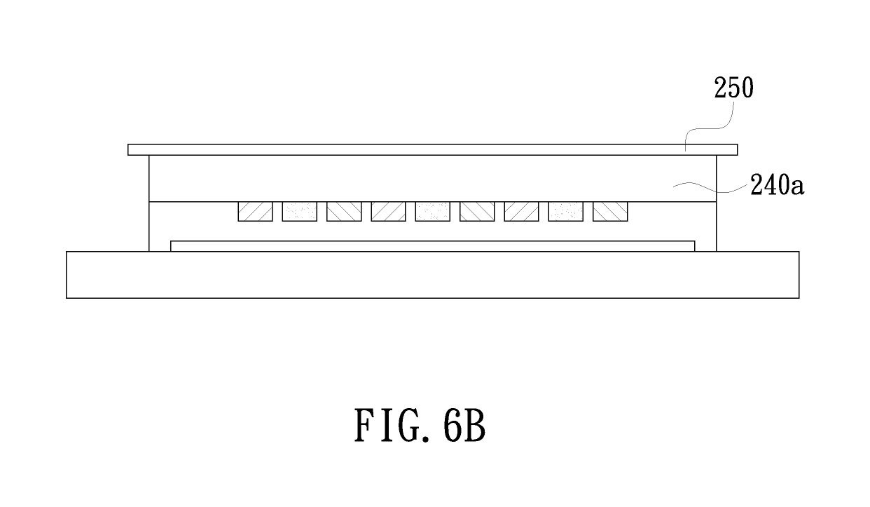

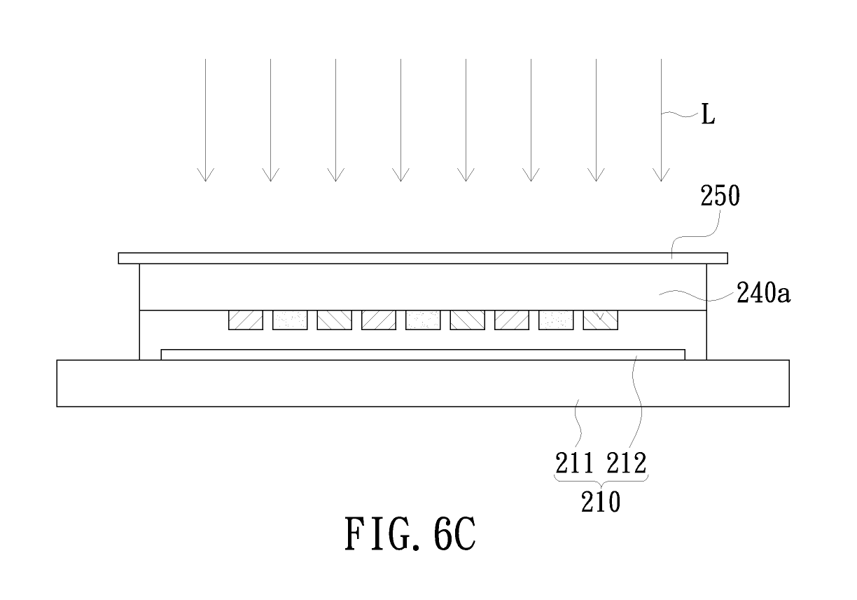

FIG. 6A to FIG. 6C show a color display apparatus throughout a manufacturing process according to another embodiment of the present disclosure. Referring to FIG. 6A, the method of manufacturing the color display apparatus 200b of FIG. 5 is similar to the method of manufacturing the abovementioned color display apparatus 200, with the difference lying in that after forming the abovementioned color display apparatus 200, a layer of liquid adhesive 240a is coated on the translucent base 221. The liquid adhesive 240a is for example an optically clear resin.

Next, as shown in FIG. 6B, the glass panel 250 is disposed on the liquid adhesive 240a.

Then, as shown in FIG. 6C, the liquid adhesive 240a is cured to form the clear adhesive layer 240 as shown in FIG. 5, and the glass panel 250 is fixed over the black-and-white display module 210 through the clear adhesive layer 240, thereby forming the color display apparatus 200b of FIG. 5. The method of curing the liquid adhesive 240a can be determined according to the type of the liquid adhesive 240a. For example, when the liquid adhesive 240a is a ultraviolet light curing adhesive, ultraviolet light L can be directed at the liquid adhesive 240a to cure the liquid adhesive 240a and form the clear adhesive layer 240. In other embodiments, the liquid adhesive can be adhesives curable by other types of light or heat. The present disclosure does not limit the type of the liquid adhesive.

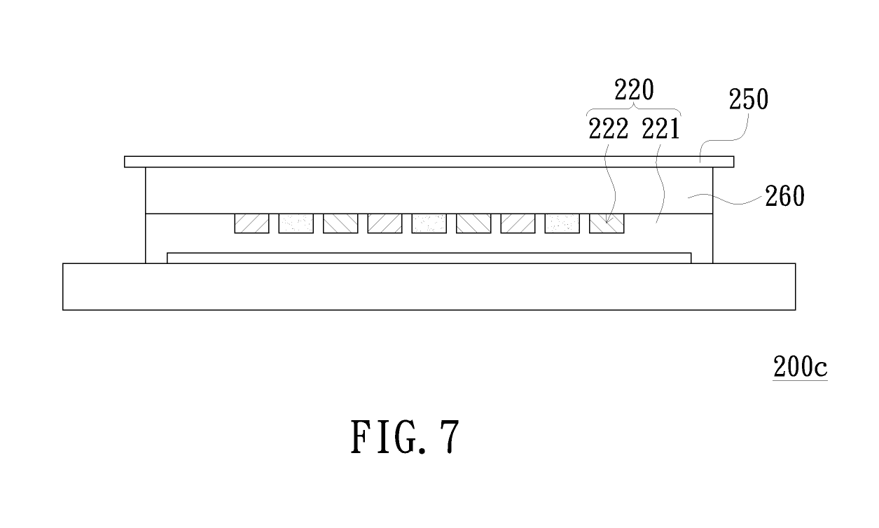

FIG. 7 shows a schematic diagram of a color display apparatus according to yet another embodiment. Referring to FIG. 7, the color display apparatus 200c in the present embodiment is similar to the abovementioned color display apparatus 200b, with the difference lying in that the type of clear adhesive layer used to serve as the protective layer is different. Specifically, regarding the color display apparatus 200c, the material of the clear adhesive layer 260 is for example an optically clear adhesive (OCA), which is an adhesive film and unlike the abovementioned optically clear resin which is formed by curing liquid adhesive.

The method of manufacturing the color display apparatus 200c in the present embodiment is similar to the method of manufacturing the abovementioned color display apparatus 200, with the difference lying in that after forming the abovementioned color display apparatus 200, the optically clear adhesive is attached onto the translucent base 221 to serve as the clear adhesive layer 260. Then, the glass panel 250 is attached onto the clear adhesive layer 260.

In summary of the above, the color display apparatus and the method of manufacturing the same according to the present disclosure at least have the following advantages.

As opposed to structures of color filter substrates of conventional techniques, regarding the color display apparatus and the method of manufacturing the same of the present disclosure, the color filter patterns are directly embedded in the translucent base arranged on the black-and-white display module, and the thin glass panel and the carrier panel of conventional techniques are not required. Therefore, the problem of attachment between the thin glass panel and the carrier panel present in conventional techniques is solved by the present disclosure, thereby increasing the manufacturing efficiency of the color display apparatus.

In an embodiment of the present disclosure, the color filter patterns are not covered by a thin glass panel, avoiding partial reflection of the ambient light by the thin glass panel, thereby increasing the optical efficiency and image display quality of the color display apparatus.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A color display apparatus, comprising:
a black-and-white display module; and
a color filter layer disposed on the black-and-white display module and comprising:
a translucent base disposed on the black-and-white display module; and
a plurality of color filter patterns embedded in the translucent base, wherein a first face of each of the color filter patterns distal from the black-and-white display module is exposed at a second face of the translucent base distal from the black-and-white display module, and the first faces of the color filter patterns and the second face of the translucent base are in contact with a dielectric gas.

2. The color display apparatus according to claim 1, wherein the material of the translucent base comprises an optically clear resin.

3. A color display apparatus comprising:
a black-and-white display module;
a color filter layer disposed on the black-and-white display module and comprising:
a translucent base disposed on the black-and-white display module; and
a plurality of color filter patterns embedded in the translucent base, wherein a first face of each of the color filter patterns distal from the black-and-white display module is exposed at a second face of the translucent base distal from the black-and-white display module; and
a protective layer having a bottom face directly contacting and covering the first faces of the color filter patterns and the second face of the translucent base, wherein the protective layer is an element selected from the group consisting of a clear adhesive layer and an optical film.

4. The color display apparatus according to claim 3, wherein the material of the translucent base comprises an optically clear resin, and the material of the clear adhesive layer comprises an optically clear resin or an optically clear adhesive.

5. The color display apparatus according to claim 3, wherein if the protective layer is the clear adhesive layer, the color display apparatus further comprises a glass panel attached to the clear adhesive layer, and a thickness of the glass panel is less than 400 micrometers.

6. The color display apparatus according to claim 3, wherein the optical film comprises an anti-reflective film or an anti-glare film.

7. A manufacturing method of a color display apparatus, comprising steps of:
forming a plurality of color filter patterns on a substrate;
coating the substrate with a liquid adhesive to cover the color filter patterns;
attaching the substrate, through the liquid adhesive, onto a black-and-white display module;
curing the liquid adhesive, wherein the liquid adhesive forms a translucent base; and
removing the substrate.

8. The manufacturing method according to claim 7, wherein the liquid adhesive comprises an optically clear resin.

9. The manufacturing method according to claim 7, further steps of:
disposing a clear adhesive layer on the translucent base; and
attaching a glass panel onto the clear adhesive layer, wherein a thickness of the glass panel is less than 400 micrometers.

10. The manufacturing method according to claim 7, further comprising a step of disposing an optical film on the translucent base.
